(19) United States
(12) Patent Application Publication
(10) Pub. No.: US 2009/0219977 A1
(43) Pub. Date: Sep. 3, 2009

(54) RADIO COMMUNICATION APPARATUS

(75) Inventor: Takanori Iwamatsu, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/392,256

(22) Filed: Feb. 25, 2009

(30) Foreign Application Priority Data
Feb. 29, 2008 (JP) 2008-050957

(51) Int. Cl. H04B 1/707; H04L 25/49

(52) U.S. Cl. 375/148; 375/296; 375/E01.02

(57) ABSTRACT

A radio communication apparatus includes a mapping unit configured to map data to a burst data transmission region corresponding to radio resources; and a transmitter configured to transmit the data mapped to the burst data transmission region, where a reference signal used for canceling an interference wave is mapped to the data transmission region.

### CROSS-REFERENCE TO RELATED APPLICATIONS

This application is based upon and claims the benefit of priority of the prior Japanese Patent Application No. 2008-50957, filed on Feb. 29, 2008, the entire contents of which are incorporated herein by reference.

### FIELD

Certain aspects of the present invention discussed herein are related to a radio communication system.

### BACKGROUND

In recent years, vigorous research and development efforts on ITS (intelligent Transport System) have been under way. As a typical system in the field of ITS, the electronic toll collection (ETC) system already finds practical application to automatically collect the charge for toll roads (express highways) and permit the road users to pass the toll gates substantially without stopping. The ETC is a system implemented by exchanging information required for toll collection by DSRC (dedicated short range communication) between the onboard equipment (OBE) mounted on automotive vehicles and the roadside equipment arranged at the entrances/exits of the toll gates. In the dedicated short range communication, a radio communication is conducted between the road and vehicles by using a radio wave, including light and other radio waves, and the communication range of dedicated short range communication is generally several to several hundred meters from the roadside equipment.

According to ITS, as illustrated in FIG. 1, for example, the radio communication is conducted between onboard equipment 20 and roadside equipment 10. The radio communication between the onboard equipment 20 and the roadside equipment 10, however, may be interfered by other systems. An example is a case in which an occupant of an automotive vehicle having the onboard equipment 20 uses a mobile phone 40. In the case where the distance is comparatively large between the mobile phone 40 and a base station unit 30 covering the cell where the mobile phone 40 is located, the transmission power of the base station unit 30 and the mobile phone 40 is large. In such a case, the radio waves transmitted from the base station unit 30 and the mobile phone 40 interfere with the communication between the onboard equipment 20 and the roadside equipment 10.

This interference is not limited to the communication between the roadside equipment 10 and the onboard equipment 20, but as illustrated in FIG. 2, the radio wave from other radio communication systems using a different frequency band, such as roadside equipment (or base station) 50, may interfere with the radio communication between the base station unit 70 and the mobile phone 60.

Depending on the range and type of communications, base station and roadside equipment may be used interchangeably to describe a fixed station for communicating with a mobile unit or onboard equipment.

Now, an interference compensation technique is explained. FIG. 3 illustrates an example of a reception unit used for the interference compensation technique. This technique includes a single-branch side lobe canceller in MIMO (multiple-input multiple-output).

The signals received by the antennas 1 and 2 are input to a in-phase mode synthesis (combining) unit 22. In the in-phase mode synthesis unit 22, the input signals are synthesized in in-phase mode. In other words, the in-phase mode synthesis unit 22 receives the input signals in diversity. The signal synthesized in in-phase mode by the common mode synthesis unit 22 is input to an opposite-phase synthesis unit 29.

The signal received from the antenna 2, on the other hand, is input to a phase/amplitude regulation unit 24. The phase/amplitude regulation unit 24 regulates the input signal in opposite phase and inputs the resultant signal to an opposite-phase synthesis unit 26. The phase/amplitude regulation unit 24 regulates the input signal in opposite phase, for example, by regulating the phase and/or amplitude of the input signal. The opposite-phase synthesis unit 26 erases the desired wave by synthesizing the signal received through the antenna 1 and the signal input through the phase/amplitude regulation unit 24. As illustrated in FIG. 4, for example, the opposite-phase synthesis unit 26 extracts the interference wave (extracted interference wave) by erasing the desired wave. The interference wave is left by reason of the fact that the desired wave and the interference wave arrive from different directions and therefore there exists a phase difference due to the route difference. The interference wave extracted by removing the desired wave in the opposite-phase synthesis unit 26 is input to a phase/amplitude regulation unit 28.

The phase/amplitude regulation unit 28 regulates the input interference wave into a phase opposite to the interference wave contained in the wave subjected to the in-phase mode synthesis by the in-phase mode synthesis unit 22. The phase/amplitude regulation unit 28, for example, regulates the input signal in opposite phase by regulating the phase and/or amplitude thereof. The interference wave thus regulated is input by the phase/amplitude regulation unit 28 to the opposite-phase synthesis unit 29.

The signal synthesized in-phase mode and input from the common mode synthesis unit 22 is synthesized with the interference wave input from the phase/amplitude regulation unit 28 by the opposite-phase synthesis unit 29 thereby to compensate for the interference.

In this interference compensation technique, it is desirable to automatically control the phase regulation amount and the amplitude regulation amount in the phase/amplitude regulation units 24 and 28.

In FIG. 3, the demodulation unit is not shown. The interference compensation described above may be carried out with either the signal before demodulation or the signal after demodulation. Whether the interference compensation is carried out for the signal before or after demodulation may be determined based on the modulation scheme employed. A different system may use a different one of the modulation schemes including CDMA (code division multiple access), OFDM (orthogonal frequency division multiplexing) and SC-FDMA (single-carrier frequency division multiple access).

The interference of the radio wave from other systems described above may be reduced also by use of a filter in the receiving unit. The use of the filter in the receiving unit, however, may not always eliminate all the radio waves transmitted from other systems. In other words, the radio waves transmitted from other systems may not be entirely isolated by the use of the filter in the receiving unit. Especially in the case where the transmission power of the radio wave from other systems is different from the transmission power of the local system, the isolation by the filter becomes more difficult. It is not easy, therefore, to entirely eliminate the interference of the radio wave transmitted by the other existing systems.

Also, according to the interference compensation technique described above, the interference wave is erased by use of the fact that the desired wave is larger than the interference wave. In the case where the interference wave is larger, therefore, the interference wave is erased, thereby making it difficult to extract the interference wave. As shown in FIG. 5, for example, the interference wave is larger than the desired wave, and therefore, the interference wave is erased. As a result, the signal extracted as an interference wave is actually a synthesized wave of the desired waves received by the antennas.

Also, this interference compensation technique is effective in the case where the radio wave arrives from a known direction. Therefore, the interference wave of which the direction of radio wave arrival cannot be specified is difficult to extract.

### SUMMARY OF THE INVENTION

Accordingly, the object of one embodiment of the invention is to reduce interference caused by radio wave transmitted from other systems.

According to one aspect of the invention, a radio communication apparatus includes a mapping unit configured to map data to a burst data transmission region corresponding to radio resources; and a transmitter configured to transmit the data mapped to the burst data transmission region, wherein a reference signal used for canceling an interference wave is mapped to the data transmission region.

According to one aspect of the invention, a radio communication apparatus includes a plurality of antennas; an interference wave extracting unit configured to extract an interference wave based on a reference signal received by the plurality of antennas, the reference signal being transmitted by a burst data transmission region by which data addressed to the radio communication apparatus is transmitted; and an interference wave canceling unit configured to perform canceling of an interference component by using the extracted interference wave.

According to one aspect of the invention, a radio communication system includes a base station unit including a mapping unit configured to map a reference signal used for removing an interference wave; and a transmitter configured to transmit the mapped reference signal; and a radio terminal unit including a plurality of antennas; a phase/amplitude calculation unit configured to determine a phase and/or amplitude to remove the reference signal included in a signal received by the plurality of the antennas, based on the reference signal; a phase/amplitude regulation unit configured to regulate a signal received by a part of the plurality of the antennas to an opposite phase, based on the phase and/or amplitude determined by the phase/amplitude calculation unit; an opposite-phase synthesis unit configured to synthesize, in opposite phase, a signal received by another part of the antennas and the signal regulated by the phase/amplitude regulation unit; and an interference wave removing unit configured to remove the interference wave from the signal received through the plurality of the antennas, based on the signal synthesized in opposite phase by the opposite-phase synthesis unit and the signal received by the plurality of the antennas.

According to one aspect of the invention, a communication method includes mapping a reference signal and data to a data transmission region addressed to a communication apparatus; transmitting the mapped reference signal and the data; determining a phase and/or amplitude to remove the reference signal, based on the reference signal included in a signal received by a plurality of antennas; regulating a signal received by a part of the plurality of antennas to an opposite phase based on the determined phase and/or amplitude; synthesizing, in opposite phase, a signal received by another part of the antennas and the regulated signal; removing an interference wave from the signal received through the plurality of the antennas, based on the signal synthesized in opposite phase and the signal received by the plurality of the antennas; and providing the data which is obtained by the removing of the interference wave to a controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates interference of radio waves transmitted from other systems;

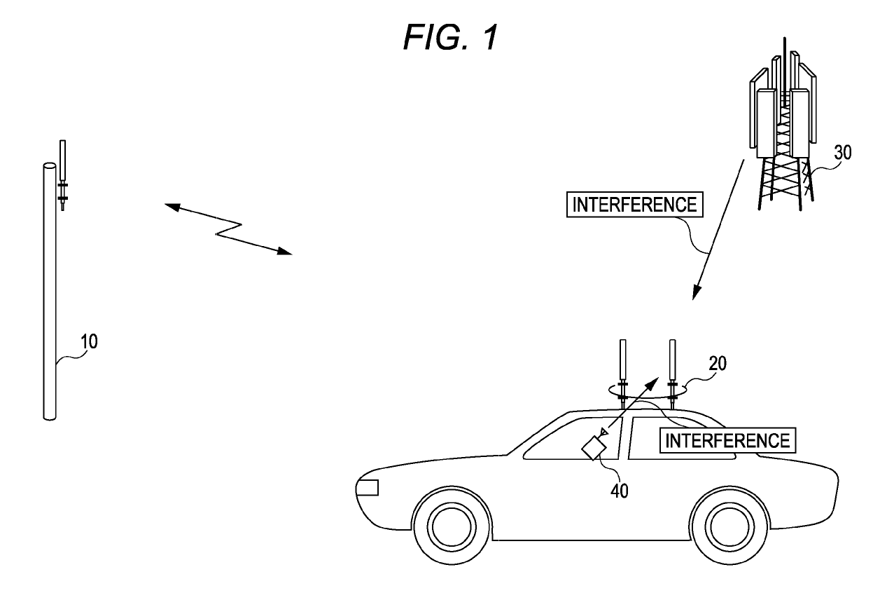

FIG. 2 illustrates interference of radio waves transmitted from other systems;

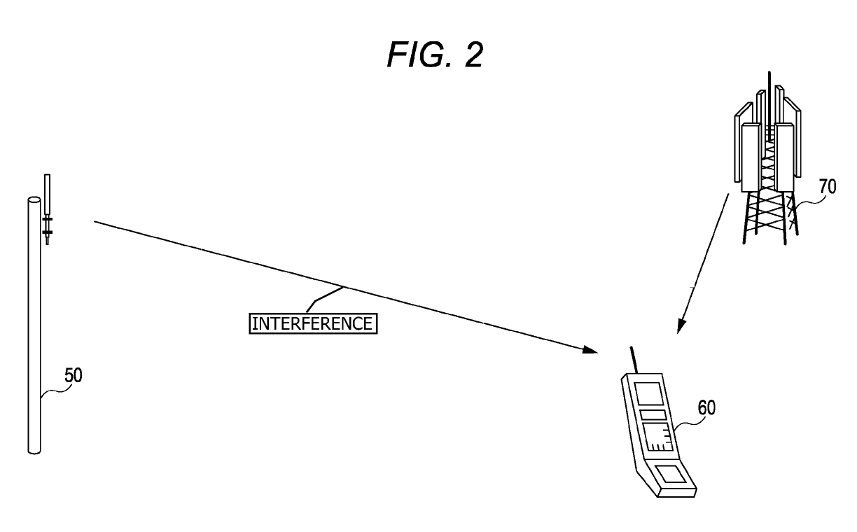

FIG. 3 illustrates an interference compensation technique;

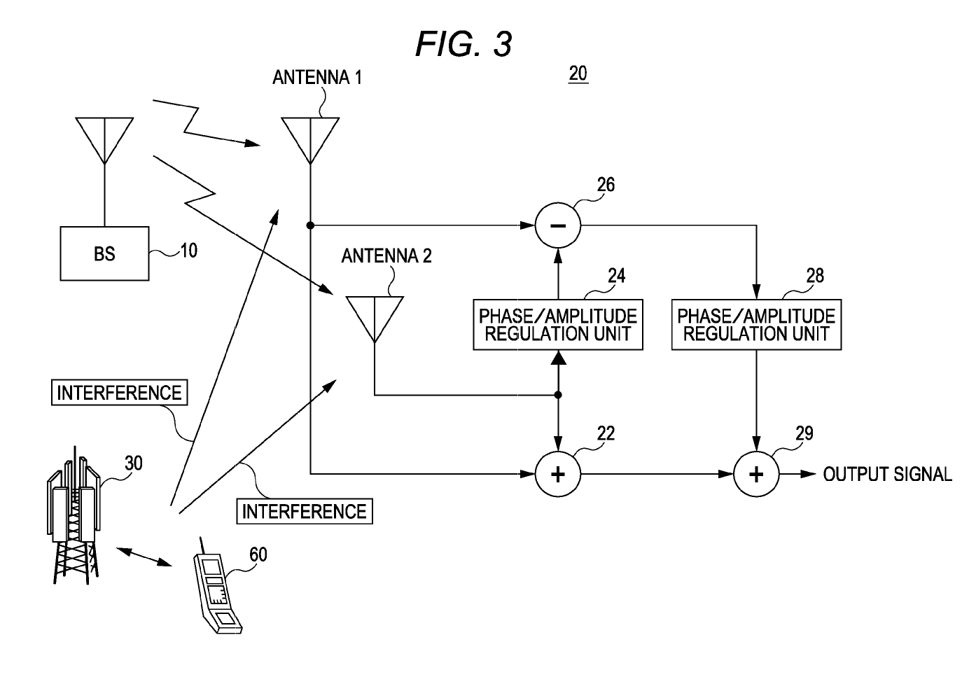

FIG. 4 illustrates an interference compensation technique;

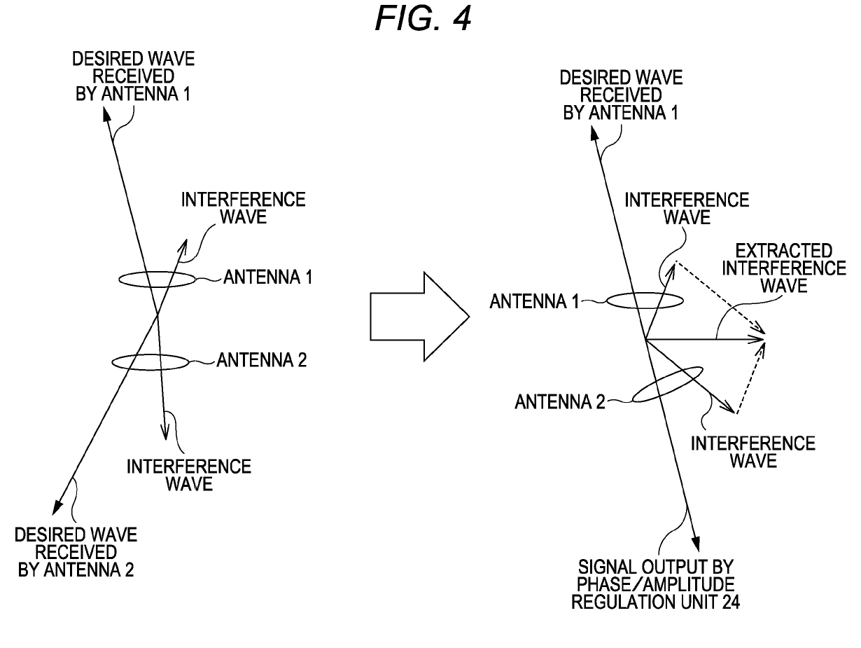

FIG. 5 illustrates an interference compensation technique;

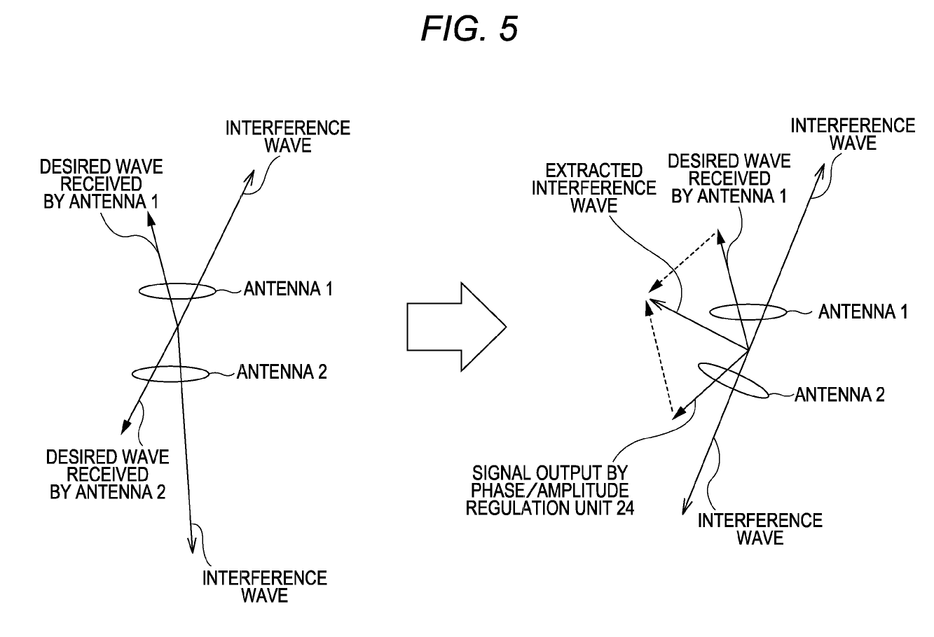

FIG. 6 is an example of a frame format;

FIG. 7 is a block diagram example of a base station unit according to an embodiment;

FIG. 8 is a block diagram example of a radio terminal unit according to an embodiment;

FIG. 9 is a block diagram example of a radio terminal unit according to an embodiment;

FIG. 10 is a block diagram example of a radio terminal unit according to an embodiment;

FIG. 11 is a block diagram example of a radio terminal unit according to an embodiment;

FIG. 12 is a flowchart example of the operation of a radio communication system according to an embodiment;

FIG. 13 is an example of a frame format;

FIG. 14 is an example of a frame format;

FIG. 15 is an example of a frame format;

FIG. 16 is a block diagram example of a radio terminal unit according to an embodiment;

FIG. 17 illustrates the operation of a radio terminal unit according to an embodiment;

FIG. 18 illustrates the operation of a radio terminal unit according to an embodiment;

FIG. 19 is a block example of a radio terminal unit according to an embodiment; and

FIG. 20 illustrates the operation of a radio terminal unit according to an embodiment.

### DESCRIPTION OF EMBODIMENTS

Embodiments for carrying out the present invention will be described below with reference to the drawings.

In all the drawings for explaining the embodiments, the component parts having the same functions are designated by the same reference numerals, respectively, and not described again.

### [a] Embodiment 1

A radio communication system according to an embodiment is explained below.

The radio communication system according to an embodiment uses a time division duplex (TDD) scheme. According to TDD, signals in up and down links may be transmitted in the same frequency band, and full duplex communication is carried out by quickly switching the down and up links. A transmission frame of the time division duplex scheme includes the down link subframe (DL subframe) for transmission of the down link signal and the up link subframe (UL subframe) for transmission of the up link signal. The down link subframe includes a known reference signal (hereinafter referred to as the training signal) used to remove an interference wave. According to this embodiment, WiMAX (Worldwide Interoperability for Microwave Access) is explained as an example. Nevertheless, other radio communication systems adapted to contain the training signal in the transmission signal may alternatively be used.

The radio communication system according to an embodiment uses the OFDM (orthogonal frequency division multiplexing) or OFDMA (orthogonal frequency division multiple access) scheme.

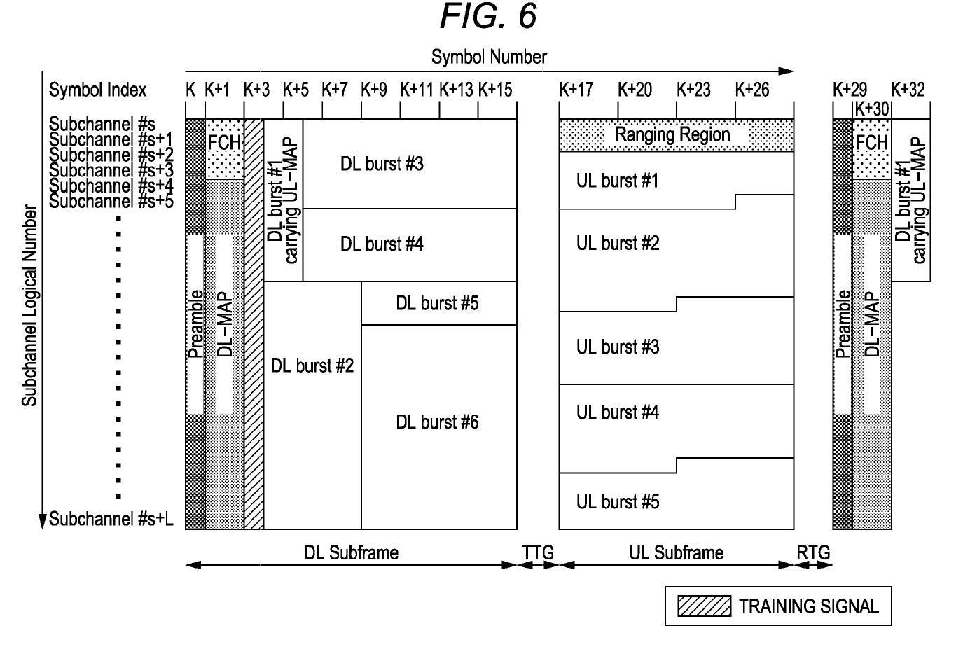

The radio communication system according to this embodiment includes a base station unit 100 and a radio terminal unit 200. The base station unit 100 and the radio terminal unit 200 conduct the radio communication with each other according to the time division duplexing. In the time division duplexing scheme, the transmission frame includes the down and up link subframes as illustrated in FIG. 6, and one frame is formed of the pair of the down and up link subframes. In FIG. 6, the ordinate represents the subchannel logical number, and the abscissa the symbol number. One slot in the down link subframe is configured of two symbols, and one slot in the up link subframe is configured of three symbols. Also, the down link subchannel includes the preamble and the control information. The preamble is used by the radio terminal unit 200 to establish synchronism with the network in the initial stage of communication. The preamble may also be used by the radio terminal unit 200 to measure the quality of the reception signal. The control information contains the frame control header (FCH), DL-MAP and UL-MAP. Also, the down link subchannel contains a down link burst (DL burst). The down link burst may be segmented (divided) into plural regions. FIG. 6 illustrates a case in which the down link burst is segmented (divided) into six regions. The up link subchannel includes a ranging region (radio resource used for ranging) and an up link burst (UL burst). The up link burst may be segmented (divided) into plural regions (radio resources). FIG. 6 illustrates a case in which the up link burst is segmented (divided) into five regions. Also, according to this embodiment, the down link burst includes the training signal. This training signal (a known signal used as a reference signal) is used by the radio terminal unit 200 to reduce the interference from other systems. FIG. 6 illustrates a case in which the training signal is mapped to a symbol following the control information.

The radio terminal unit 200 has a plurality of antennas. According to this embodiment, an example is explained about a case in which the radio terminal unit 200 has two antennas. Nevertheless, the invention is also applicable to the case in which the radio terminal unit 200 has three or more antennas.

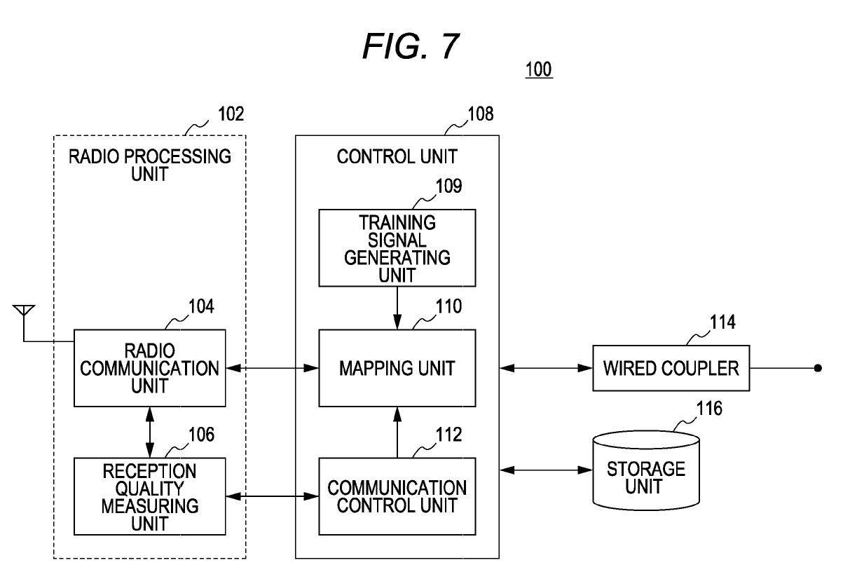

The base station unit 100 according to this embodiment is explained with reference to FIG. 7.

The base station unit 100 has a radio processing unit 102. The radio processing unit 102 transmits a down link signal in the down link subframe. The down link signal thus transmitted contains the preamble, the frame control header, DL-MAP, UL-MAP and the down link burst. The down link burst contains the training signal. Also, the radio processing unit 102 receives the initial ranging code transmitted by the initial ranging process from the radio terminal unit 200. In a predetermined ranging region, the radio processing unit 102 waits for the initial ranging code transmitted from the radio terminal unit 200. Also, the radio processing unit 102 measures the reception quality of the initial ranging code thus received.

The radio processing unit 102 includes a radio communication unit 104. The radio communication unit 104 transmits the down link signal in the down link subframe. The down link signal includes the preamble, the frame control header, DL-MAP, UL-MAP and the down link burst. The down link burst includes the training signal. Also, in a predetermined ranging region, the radio communication unit 104 waits for the initial ranging code transmitted from the radio terminal unit 200, and receives the initial ranging code transmitted through the initial ranging process from the radio terminal unit 200. The initial ranging code is expressed by predetermined symbols or, for example, by two symbols. The base station unit 100, though illustrated to have an antenna in FIG. 7, may alternatively have a plurality of antennas.

The radio processing unit (processor) 102 may include a reception quality measuring unit 106. The reception quality measuring unit 106 measures the reception quality of the initial ranging code received by the radio communication unit (transceiver) 104. The reception quality measuring unit 106 measures, for example, the RSSI (receive signal strength indicator) and the time offset of the initial ranging code received by the radio communication unit 104. The reception quality thus measured is input to the control unit (controller) 108.

The base station unit 100 includes the control unit (controller) 108. The control unit 108 maps the down link signal in the down link subframe. Also, the base station unit 100 controls the communication based on the reception quality of the ranging code transmitted from the radio terminal unit 200. The control unit 108 generates the training signal.

The control unit 108 may include a training signal generating unit (training signal generator) 109. The training signal generating unit 109 generates a (known) reference signal to be used for removing the interference wave in the radio terminal unit 200. The training signal generating unit 109 inputs the generated training signal to the mapping unit 110. The training signal may include, for example, a random series.

The control unit 108 includes a mapping unit 110. The mapping unit 110 maps the down link signal to the subchannel in the down link subframe. As illustrated in FIG. 6, for example, the preamble is mapped to the leading symbol in the down link subframe. Then, the frame control header and DL-MAP are mapped to the second leading symbol. The down link burst is mapped to the third leading symbol. The down link burst includes the training signal used by the radio terminal unit 200 to remove the interference by the radio wave transmitted from other systems. FIG. 6 illustrates an example of mapping, which can be appropriately changed.

The control unit 108 includes a communication control unit (communication controller) 112. The communication control unit 112 makes the scheduling based on the reception quality of the initial ranging code input by the reception quality measuring unit 106.

The base station unit 100 includes a wired coupler 114. The wired coupler 114 connects the base station unit 100 with a super-ordinate apparatus. For example, the super-ordinate apparatus may be a control station or a core network.

The base station unit 100 includes a storage unit 116. The storage unit 116 stores the information on the ranging region to wait for the initial ranging code transmitted from the radio terminal unit 200, i.e. the information on the radio resources with the initial ranging code transmitted therein.

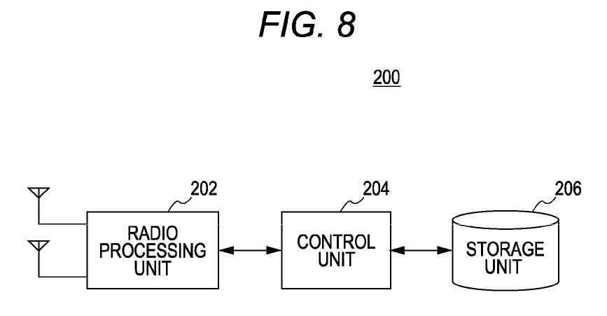

The radio terminal unit 200 according to this embodiment is explained with reference to FIG. 8.

The radio terminal unit 200 includes a radio processing unit (transceiver) 202. The radio processing unit 202 executes the process of synchronization with the preamble contained in the down link subframe transmitted from the base station unit 100. The radio processing unit 202 also executes the process of receiving the down link subframe transmitted by the base station unit 100. Further, the radio processing unit 202 transmits the initial ranging code in a predetermined ranging region after the synchronization process for the preamble. Also, the radio processing unit 202 removes the interference of the radio waves transmitted from other systems, based on the training signal included in the down link subframe (burst region(#2, #3, #4, #5 and #6)).

Also, the radio terminal unit 200 includes a storage unit 206. The storage unit 206 stores the information on the initial ranging region with which the initial ranging code is transmitted by the radio terminal unit 200, i.e. the information on the radio resources to transmit the initial ranging code.

The radio terminal unit 200 includes a control unit (controller) 204. The control unit 204 performs the control operation in such a manner so that the radio terminal unit 200 transmits the initial ranging code using the ranging region, which is managed by the radio terminal unit 200 by storing ranging region information (radio resource for transmission of ranging code) in the storage unit 206, after establishing the synchronization with the base station unit 100. Also, the radio terminal unit 200, based on the down link radio frame transmitted by the base station unit 100, detects the profile information of the following down link burst through the frame control header, while at the same time detecting the length information, the profile and the schedule of the TDM burst in the down link subframe through the DL-MAP on the one hand and the length information, the profile and the schedule of the TDM burst in the up link subframe through the UL-MAP on the other hand. The radio terminal unit 200 thus detects the frame structure through the DCD (Downlink Channel Descriptor)/UCD(Uplink Channel Descriptor).

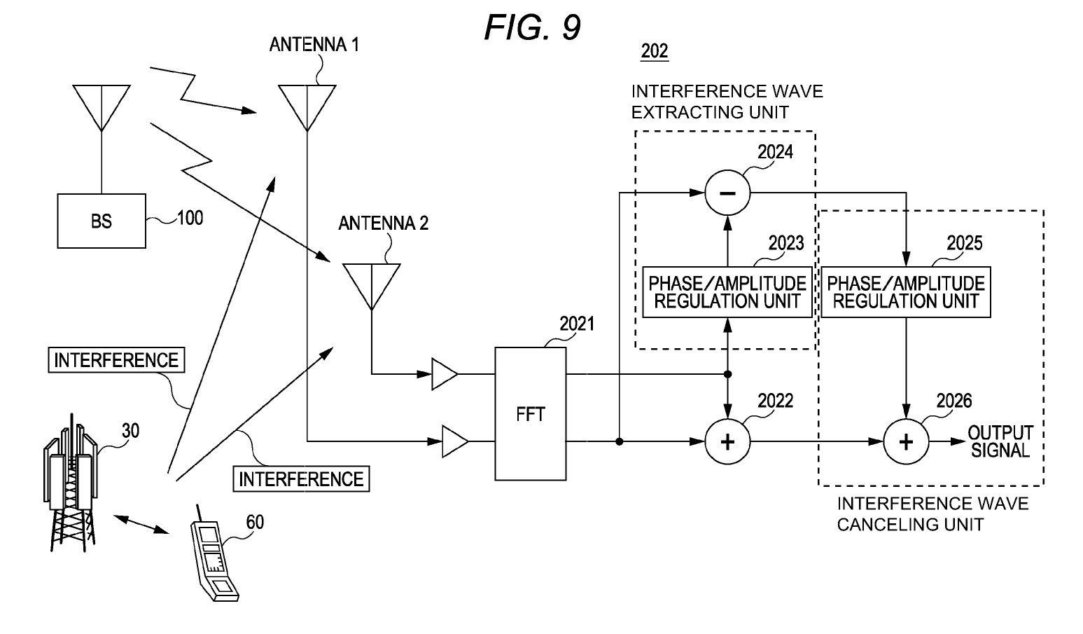

The radio processing unit (processor) 202 of the radio terminal unit 200 according to this embodiment is explained in detail with reference to FIG. 9. As described above, the radio processing unit 202, based on the training signal (predetermined signal) included in the down link signal, removes the interference of the radio wave transmitted from other systems.

The radio processing unit 202 may include a fast Fourier transform (FFT) unit 2021. The FFT unit 2021 is supplied with the signals received through the antennas 1 and 2 each amplified by an amplifier. The FFT unit 2021 subjects the signal from each antenna to the fast Fourier transform. The signal input from the antenna 1 and subjected to the fast Fourier transform is input by the FFT unit 2021 to the in-phase mode synthesis unit 2022 and the opposite-phase synthesis unit 2024. Also, the signal input from the antenna 2 and subjected to the fast Fourier transform is input by the FFT 2021 to the in-phase mode synthesis unit 2022 and the phase/amplitude regulation unit 2023 described later.

The radio processing unit 202 includes the in-phase mode synthesis unit 2022. The signals input from the antennas 1 and 2 and subjected to the fast Fourier transform by the FFT unit 2021 are subjected to in-phase mode synthesis by the common mode synthesis unit 2022. The signal synthesized in in-phase mode is input by the in-phase mode synthesis unit 2022 to the interference wave removing unit 2026 described later.

The radio processing unit 202 may include the phase/amplitude regulation (adjusting) unit 2023 performing a phase/amplitude adjustment at the same time. The signal input from the antenna 2 and subjected to fast Fourier transform is regulated (adjusted) to the opposite phase by the phase/amplitude regulation unit 2023 and input to the opposite-phase synthesis unit 2024, wherein the combination of the phase/amplitude regulation unit 2023 and the opposite-phase synthesis unit 2024 is used as an interference wave extracting unit. The phase/amplitude regulation unit 2023, based on the training signal included in the signal from the antenna 2 and subjected to fast Fourier transform, determines the phase and/or the amplitude in such a manner as to remove the training signal. The phase and/or the amplitude is determined based on the training signal. For other than the training signal, the phase and/or the amplitude is not determined and the phase and/or the amplitude determined based on the training signal is held. Then, the signal input from the antenna 2 and subjected to fast Fourier transform is regulated to the opposite phase by the phase/amplitude regulation unit 2023 based on the phase and/or the amplitude thus determined.

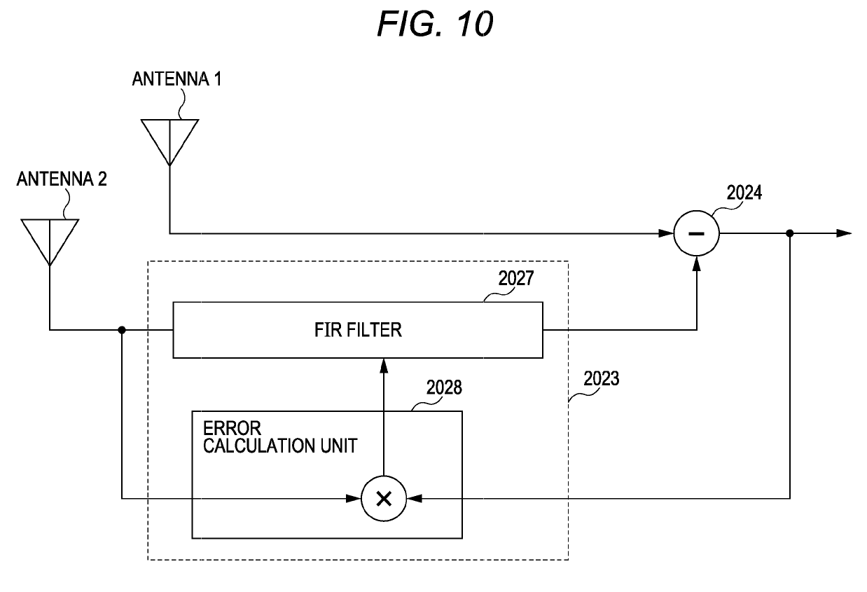

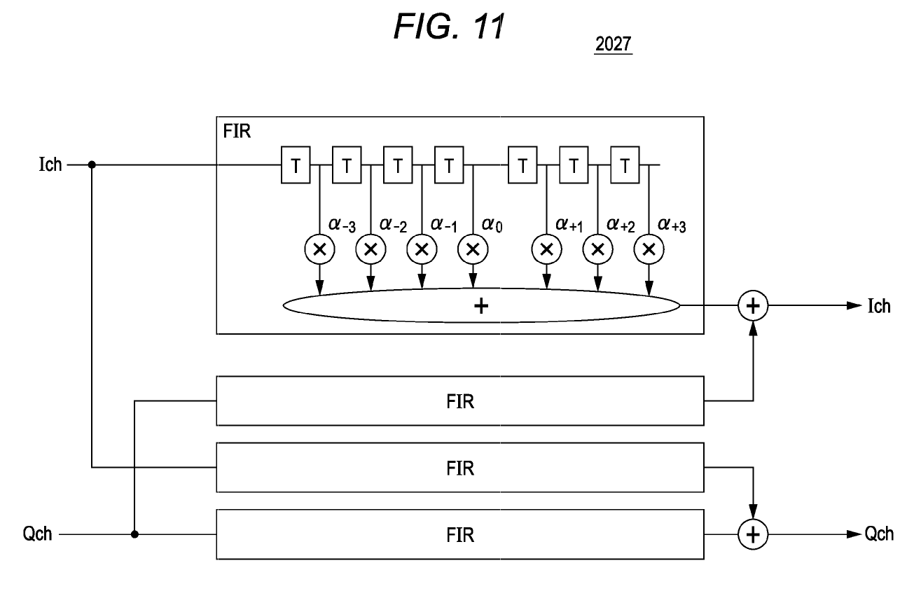

The phase/amplitude regulation unit 2023 may be configured of, for example, a FIR (finite impulse response) filter. In this case, as illustrated in FIG. 10, the phase/amplitude regulation unit 2023 may include a FIR filter 2027 and an error calculation unit 2028. Each tap coefficient of the FIR filter 2027 corresponds to the phase and amplitude. In order to determine this TAP coefficient, the phase/amplitude regulation unit 2023 may use, as an error, the product of the input signal from the antenna 2 and the signal after the opposite-phase synthesis, i.e. the output signal of the opposite-phase synthesis unit 2024, i.e. the signal after the opposite-phase synthesis. An example of the FIR filter 2027 is illustrated in FIG. 11. The FIR filter 2027 includes delay elements T, multipliers and an adder. The number of the delay elements T is determined by the delay difference between the antennas 1 and 2. Also, the coefficient α is multiplied in each multiplier, where α is determined in such a manner as to minimize the error. The coefficient α may alternatively be determined by, for example, the MMSE (minimum mean square error elimination) control method. The MMSE control method is based on the estimation to minimize the mean square error between the continuous parameter and the estimated value thereof.

The radio processing unit 202 includes the opposite-phase synthesis unit 2024. In the opposite-phase synthesis unit 2024, the signal input through the antenna 1 and subjected to the fast Fourier transform by the FFT unit 2021 is synthesized with the signal input by the phase/amplitude regulation unit 2023. As a result, the training signal included in the signal from the antenna 1 and the training signal included in the signal input by the phase/amplitude regulation unit 2023 are erased, and the interference wave is extracted. In the opposite-phase synthesis unit 2024, the synthesis signal between the signal input through the antenna 1 by the FFT unit 2021 and the signal input by the phase/amplitude regulation unit 2023, i.e. the interference wave is input to the phase/amplitude regulation unit 2025.

The radio processing unit 202 may include the phase/amplitude regulation unit 2025. The phase/amplitude regulation unit 2025 regulates the input interference wave to the phase opposite to the interference wave included in the synthesized wave. For example, the phase/amplitude regulation unit 2025, as illustrated in FIGS. 10 and 11, may be configured of the FIR filter. The phase/amplitude regulation unit 2025 applies the regulated interference wave to an opposite-phase synthesis unit 2026, wherein the combination of the phase/amplitude regulation unit 2025 and the opposite-phase synthesis unit 2026 is used as an interference canceling (or removing) unit.

The radio processing unit 202 may include the interference removing unit. In the interference removing unit, the signal obtained by in-phase synthesizing in the in-phase mode synthesis unit 2022 is synthesized with the interference wave input by the phase/amplitude regulation unit 2025 thereby to erase the interference. As a result, a signal with the interference wave compensated is obtained. The signal with the interference wave compensated is input to the control unit (controller) 204 by the interference removing unit.

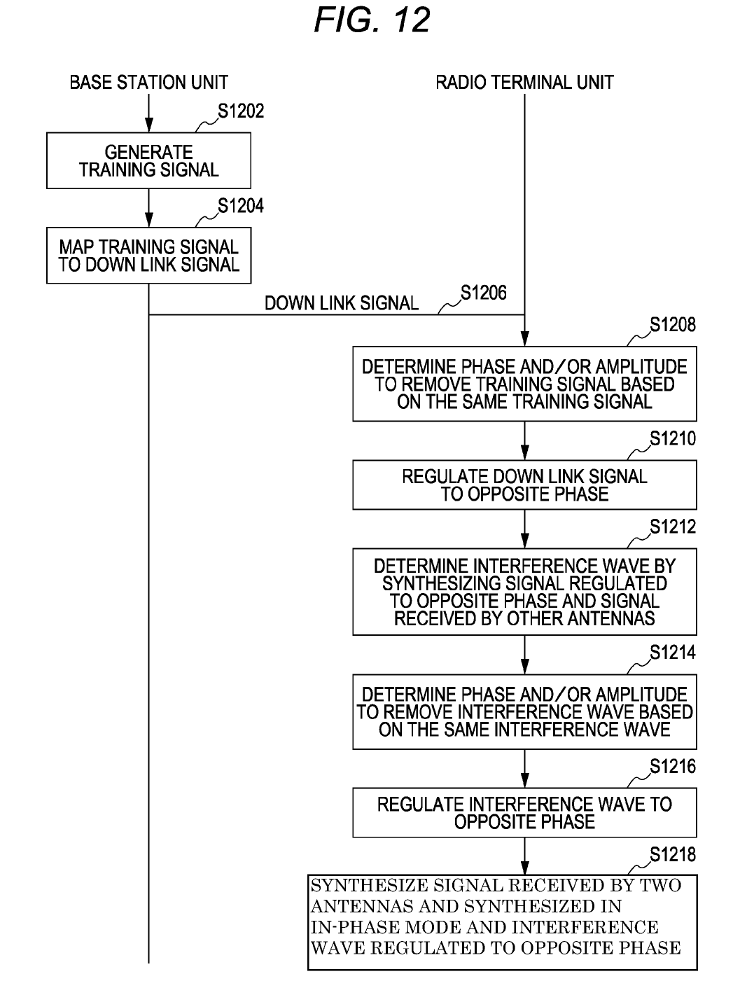

The operation of the radio communication system according to this embodiment is explained with reference to FIG. 12.

The base station unit 100 generates the training signal (step S1202)

The base station unit 100 maps the generated training signal to the down link subframe (step S1204).

The base station unit 100 transmits the down link subframe (step S1206),

The radio terminal unit 200 receives the down link signal. The radio terminal unit 200, based on the training signal included in the down link signal received by one of the antennas, determines the phase and/or the amplitude in such a manner as to remove the particular training signal (step S1208).

The radio terminal unit 200, based on the phase and/or the amplitude determined in step S1208, regulates the down link signal received by one of the antennas to the opposite phase (step S1210).

The down link signal regulated to the opposite phase in step S1210 and the down link signal received by the other antenna are synthesized with each other by the radio terminal unit 200 (step S1212). As a result, an interference wave is obtained (extracted).

Based on the interference wave obtained in step S1212, the radio terminal unit 200 determines the phase and/or the amplitude in such a manner as to remove the interference wave (step S1214).

The radio terminal unit 200, based on the phase and/or the amplitude obtained in step S1214, regulates the interference wave to the opposite phase (step S1216).

In the radio terminal unit 200, the signals received by the antennas 1 and 2 and synthesized in in-phase mode with each other are synthesized with the interference wave regulated to opposite phase in step S1216 (step S1218).

According to this embodiment, the base station unit 100 transmits the down link signal including the training signal used for removing (erasing) the interference wave. The radio terminal unit 200 may remove the interference wave using the particular training signal. The radio resources for the radio terminal unit 200 to map the training signal may be known. The radio terminal unit 200, therefore, can extract the interference wave by regulating the phase and/or the amplitude in such a manner as to remove this training signal. Also, the training signal is mapped to the radio resources other than those to which the control signal is mapped, i.e. mapped to the radio resources to which the data is mapped. In this way, the radio resources for mapping may be changed.

According to this embodiment, an explanation is given about a case in which the symbol immediately following the control information is used, as illustrated in FIG. 6, as an example of the radio resources to which the training signal is mapped. Nevertheless, the embodiment is not limited to this example.

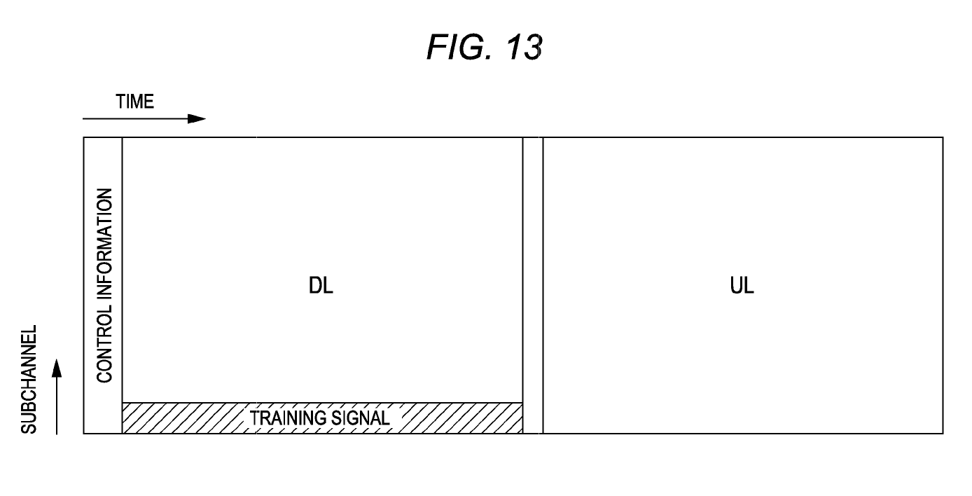

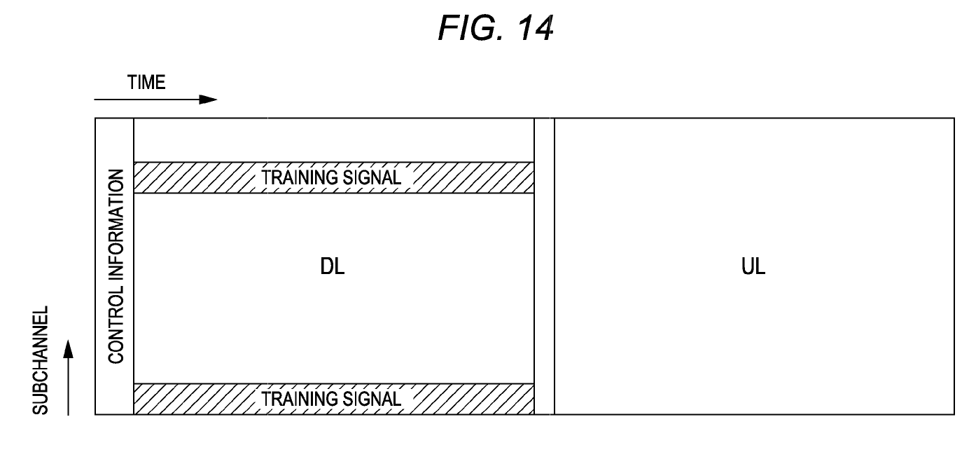

As illustrated in FIG. 13, for example, the training signal may be mapped to a given subchannel. Also, as illustrated in FIG. 14, the training signal may be mapped to plural subchannels. FIG. 14 illustrates a case in which the training signal is mapped to two subchannels. In this case, for example, the phase and/or the amplitude may be the average value of the phase and/or the amplitude determined from each training signal. By mapping this way, the temporal lag can be reduced which otherwise might be caused in the case where the phase and/or the amplitude of the down link signal is regulated based on the phase and/or the amplitude obtained using the training signal.

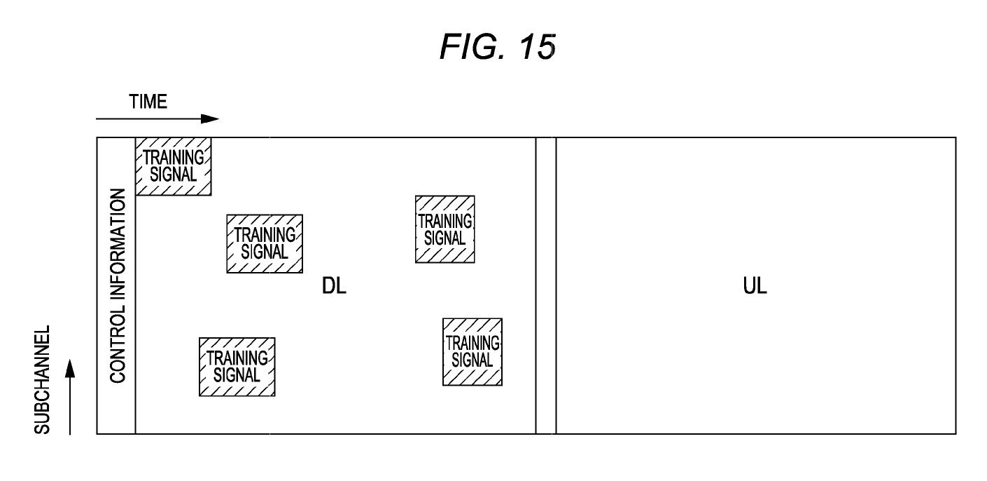

Also, as illustrated in FIG. 15, the training signal may be mapped to a block configured of one or plural subchannels and one or plural symbols. In this case, the training signal may be mapped to a single or plural blocks. Also, the size of each block may be varied. FIG. 15 illustrates a case in which the training signal is mapped to plural blocks of different sizes. As an example, the training signal is mapped with a resource element as a unit. In this case, one resource element includes one subchannel and one symbol. Also, the phase and/or the amplitude may be the average value of the phase and/or the amplitude determined by each training signal. By mapping this way, the effect of the reception characteristic of the training signal dependent on the frequency can be alleviated.

Incidentally, the training signal is assumed to be a signal different from the preamble. The preamble, though a known signal, affects the cell radius, etc. In the aforementioned embodiment using the training signal separately, therefore, the cell radius is less affected, unlike the preamble, even in the case where the transmission parameter is changed to remove the interference. Also, even in the case where the training signal is subjected to the spreading process described later, the effect on cell detection, etc. is small. Once the preamble is subjected to the spreading process, etc., on the other hand, the de-spreading process would be forced also on the terminals not executing the interference removing process, or a terminal unable to recognize a particular interference removing process executed might become incapable of the communication at all.

### [b] Embodiment 2

The configuration of the radio communication system according to a second embodiment is similar to that of the first embodiment described above.

The configuration of the base station unit 100 according to this embodiment is similar to the configuration described above with reference to FIG. 7.

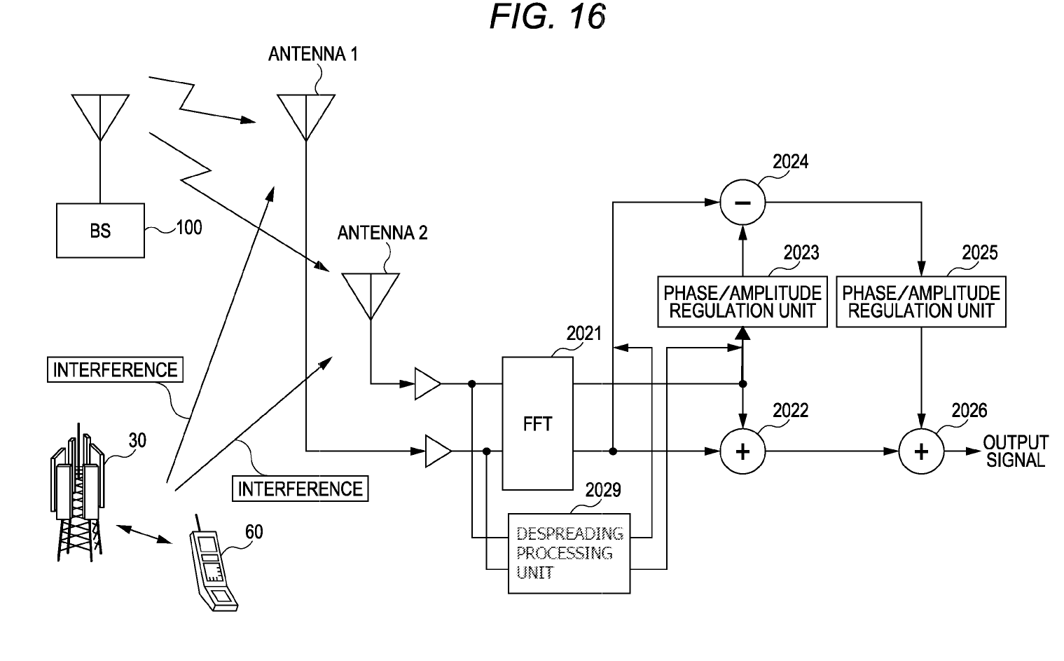

The configuration of the radio terminal unit 200 according to this embodiment is also similar to the corresponding configuration described above with reference to FIG. 8. In the radio processing unit 202 of the radio terminal unit 200 according to this embodiment, as illustrated in FIG. 16, an inverted diffusion (despreading) processing unit 2029 is included in the radio processing unit 202 described with reference to FIG. 9. The de-spreading processing unit 2029 executes the de-spreading process on the radio resources containing the training signal. The training signal subjected to the de-spreading process is input to the phase/amplitude regulation unit 2023 by the de-spreading processing unit 2029.

The phase/amplitude regulation unit 2023, based on the input training signal subjected to the de-spreading process, determines the phase and/or the amplitude in such a manner as to remove the training signal. This phase and/or the amplitude is determined based on the training signal. As for other than the training signal, the phase and/or the amplitude is not determined, but the phase and/or the amplitude already determined based on the training signal is held. Then, in the phase/amplitude regulation unit 2023, based on the phase and/or the amplitude thus determined, the signal input by the FFT unit 2021 from the antenna 2 and subjected to the FFT process is regulated to the opposite phase by the phase/amplitude regulation unit 2023.

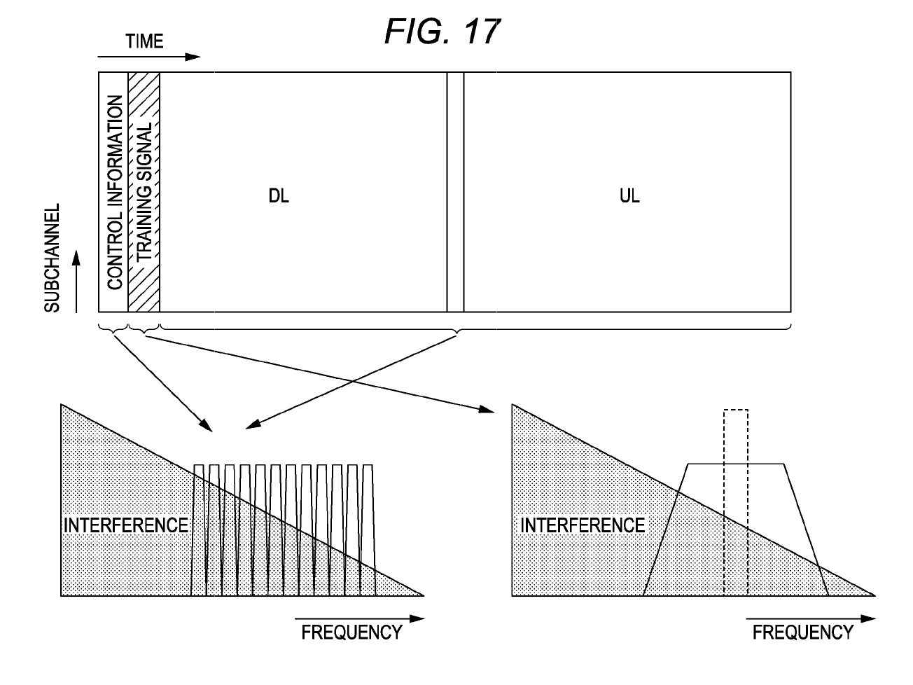

According to this embodiment, the de-spreading process may be executed by mapping the training signal to the radio resources other than those to which the control information is mapped. Also, the carrier-to-noise ratio for the training signal may be improved. As illustrated in FIG. 17, for example, the signals other than the training signal are affected by the interference wave. As a result, the spread signal may be buried in the interference wave. By executing the de-spreading process for the spread training signal indicated by solid line, however, the information signal for the training signal indicated by dashed line can be obtained. Since the signals other than the training signal remain spread, the interference component included in the information signal for the training signal is reduced below the interference component of the spread training signal. Thus, the carrier-to-noise ratio of the training signal may be improved.

### [c] Embodiment 3

The configuration of the radio communication system according to the third embodiment is similar to that of the embodiments described above.

The configuration of the base station unit 100 according to this embodiment is similar to that explained above with reference to FIG. 7.

The radio terminal unit 200 according to this embodiment has a similar configuration to the one explained with reference to FIG. 8. The radio processing unit 202 of the radio terminal unit 200 according to this embodiment is similar to the radio processing unit 202 explained with reference to FIG. 9.

The base station unit 100 according to this embodiment controls the transmission power in such a manner that the transmission power of the training signal is higher than that of the signals (for example, the preamble and the burst data) other than the training signal. Specifically, the radio communication unit 104 controls the transmission power in such a manner that the transmission power of the symbol corresponding to the training signal is high.

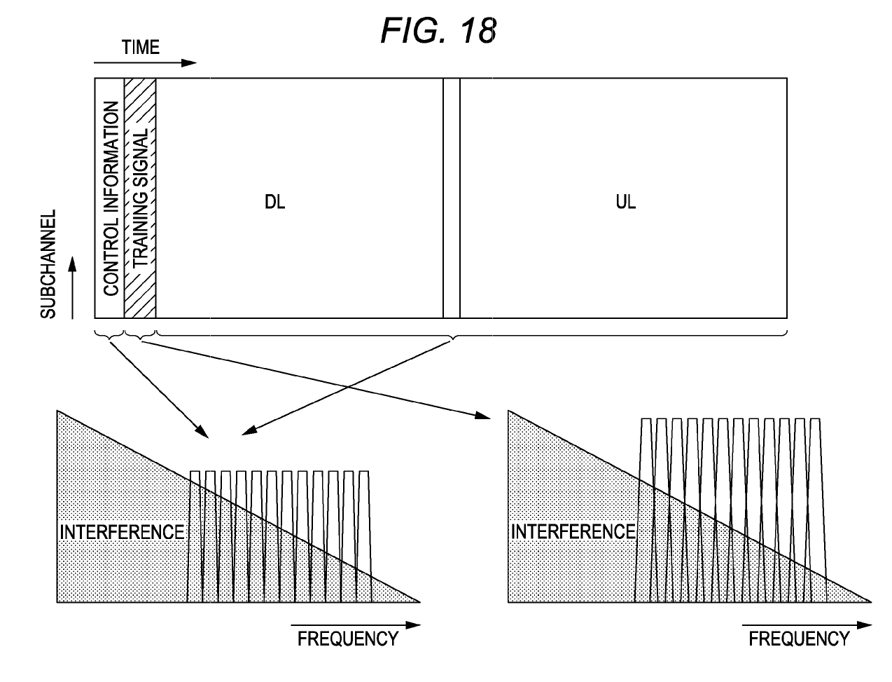

According to this embodiment, the training signal is mapped to the radio resources other than those to which the control signal is mapped, thereby making it possible to increase the margin of change of the particular transmission power. Also, the carrier-to-noise ratio in the training signal may be improved. As illustrated in FIG. 18, for example, the signals other than the training signal are greatly affected by the interference wave. As a result, the spread signal may be buried in the interference wave. Since the transmission power is controlled in such a manner as to secure a high transmission power of the training signal, however, the effect of the interference wave on the training signal may be reduced in the radio terminal unit 200. Thus, the carrier-to-noise ratio in the training signal may be improved.

### [d] Embodiment 4

The configuration of the radio communication system according to this embodiment is similar to those of the embodiments described above.

The configuration of the base station unit 100 according to this embodiment is similar to that explained above with reference to FIG. 7.

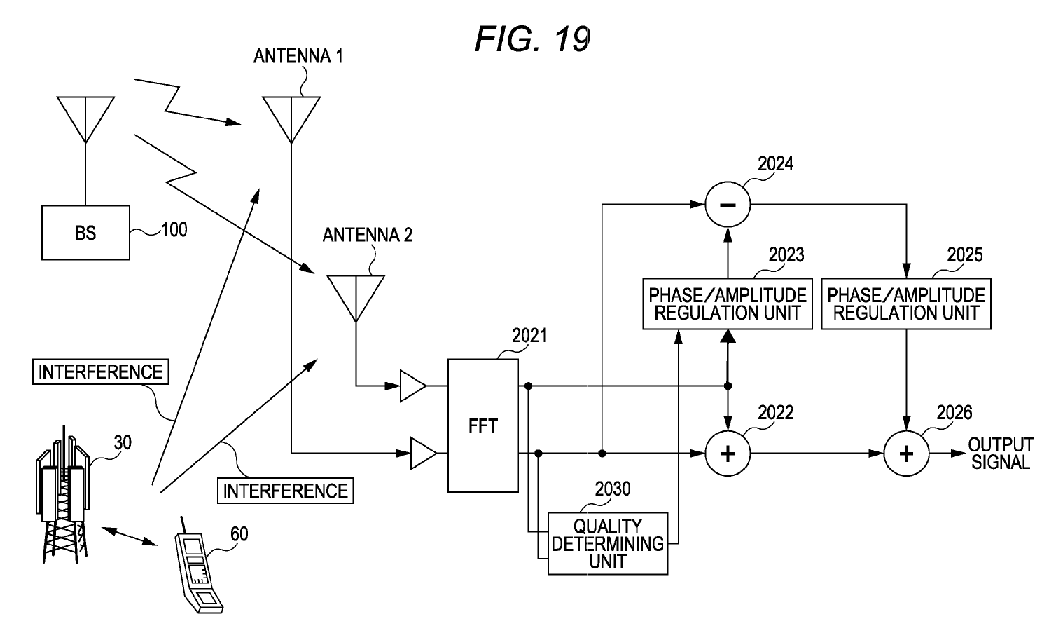

The radio terminal unit 200 according to this embodiment includes a similar configuration to the one explained with reference to FIG. 8. The radio processing unit 202 of the radio terminal unit 200 according to this embodiment, as illustrated in FIG. 19, includes a quality determining unit 2030 included in the radio processing unit 202 described with reference to FIG. 9. The quality determining unit 2030 judges whether the measured reception quality of the training signal is not lower than a predetermined threshold value. The threshold value is determined, for example, based on the reception quality required to determine the phase and/or the amplitude in the phase/amplitude regulation unit 2023. In the case where the reception quality of the training signal is not lower than the predetermined threshold value, the quality determining unit 2030 notifies the phase/amplitude regulation unit 2023 that the phase and/or the amplitude may be calculated using the particular training signal, otherwise the phase and/or the amplitude may not be calculated using the deteriorated training signal. The phase/amplitude regulation unit 2023, in accordance with the notification from the quality determining unit 2030, calculates the phase and/or the amplitude. The radio terminal unit 200 may measure, for example, the CINR (carrier-to-interference plus noise ratio) of the training signal. In this case, the quality determining unit 2030 judges whether the measured CINR of the training signal is not less than a predetermined threshold value or not. The CINR may alternatively be determined from the spread value of the reception signal point.

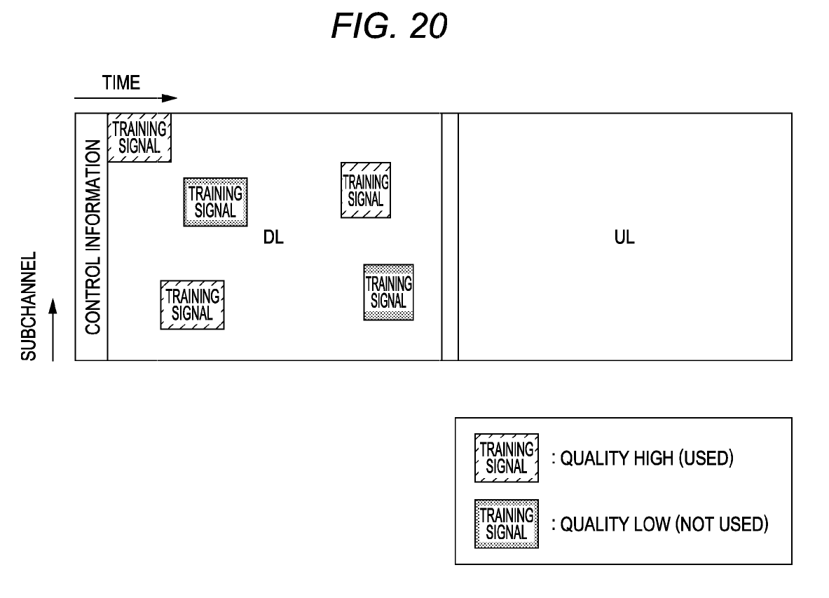

As illustrated in FIG. 20, for example, the phase/amplitude regulation unit 2023 calculates the phase and/or the amplitude using the training signal of which the reception quality is not less than the threshold value.

According to this embodiment, the phase and/or the amplitude is calculated using the training signal with a high reception quality, and therefore, the accuracy with which the phase and/or the amplitude is calculated may be improved.

In the radio communication apparatus according to embodiments explained above, the interference of the radio wave transmitted from other systems may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that various changes, substitutions, and alterations could be made hereto without departing from the spirit and scope of the invention.

What is claimed is:

1. A radio communication apparatus comprising:
a mapping unit configured to map data to a burst data transmission region corresponding to radio resources; and
a transmitter configured to transmit the data mapped to the burst data transmission region,
wherein a reference signal used for canceling an interference wave is mapped to the burst data transmission region.

2. The radio communication apparatus according to claim 1, wherein a transmission power assigned to a radio resource by which the reference signal is transmitted is higher than a transmission power assigned to a radio resource by which a data signal or a preamble signal is transmitted.

3. The radio communication apparatus according to claim 1, wherein the radio resources use one resource element as a unit, and one resource element includes one symbol and one subchannel, and
the mapping unit maps the reference signal with the one resource element used as the unit.

4. The radio communication apparatus according to claim 1, wherein the mapping unit maps the reference signal to one or more subchannels.

5. A radio communication apparatus comprising:
a plurality of antennas;
a phase/amplitude calculation unit configured to determine a phase and/or amplitude, based on a reference signal received by the plurality of the antennas;
a phase/amplitude regulation unit configured to regulate a signal received by a part of the plurality of the antennas to an opposite phase, based on the phase and/or amplitude determined by the phase/amplitude calculation unit;
an opposite-phase synthesis unit configured to synthesize in opposite phase a signal received by another part of the antennas and the signal regulated by the phase/amplitude regulation unit; and
an interference wave removing unit configured to remove an interference wave from a signal received through the plurality of the antennas, based on the signal synthesized in opposite phase by the opposite-phase synthesis unit and the signal received through the plurality of the antennas.

6. The radio communication apparatus according to claim 5, further comprising a de-spreading processing unit configured to de-spread the reference signal,
wherein the phase/amplitude calculation unit determines the phase and/or amplitude, based on the de-spread reference signal.

7. The radio communication apparatus according to claim 5, further comprising a reception quality determining unit configured to judge whether a reception quality of the reference signal is not less than a threshold value,
wherein the phase/amplitude calculation unit determines the phase and/or amplitude based on the reference signal when judged as not less than the threshold value by the reception quality determining unit.

8. A radio communication apparatus comprising:
a plurality of antennas;
an interference wave extracting unit configured to extract an interference wave based on a reference signal received by the plurality of antennas, the reference signal being transmitted by a burst data transmission region by which data addressed to the radio communication apparatus is transmitted; and
an interference wave canceling unit configured to perform canceling of an interference component by using the extracted interference wave.

9. A radio communication system comprising:
a base station unit including a mapping unit configured to map a reference signal used for removing an interference wave;
a transmitter configured to transmit the mapped reference signal;
a radio terminal unit including a plurality of antennas;
a phase/amplitude calculation unit configured to determine a phase and/or amplitude to remove the reference signal included in a signal received by the plurality of the antennas, based on the reference signal;
a phase/amplitude regulation unit configured to regulate a signal received by a part of the plurality of the antennas to a opposite phase, based on the phase and/or amplitude determined by the phase/amplitude calculation unit;
an opposite-phase synthesis unit configured to synthesize in opposite phase a signal received by another part of the antennas and the signal regulated by the phase/amplitude regulation unit; and
an interference wave removing unit configured to remove the interference wave from the signal received by the plurality of the antennas, based on the signal synthesized in opposite phase by the opposite-phase synthesis unit and the signal received by the plurality of the antennas.

10. A communication method comprising:
mapping a reference signal and data to a data transmission region addressed to a communication apparatus;
transmitting the mapped reference signal and data;
determining a phase and/or amplitude to remove the reference signal, based on the reference signal included in a signal received by a plurality of antennas;
regulating a signal received by a part of the plurality of antennas to an opposite phase based on the determined phase and/or amplitude;
synthesizing in opposite phase a signal received by another part of the antennas and the regulated signal;
removing an interference wave from the signal received by the plurality of the antennas, based on the signal synthesized in opposite phase and the signal received by the plurality of the antennas; and
providing the data which is obtained by the removing of the interference wave to a controller.
